(19) United States
(12) Patent Application Publication
(10) Pub. No.: US 2012/0085298 A1
(43) Pub. Date: Apr. 12, 2012

(54) FLASHING DOG COLLAR FOR ANIMALS, ESPECIALLY DOGS

(75) Inventor: Frank Wolters, Dotlingen (DE)

(73) Assignee: WOLTERS CAT & DOG GMBH, Thedinghausen (DE)

(21) Appl. No.: 13/267,192

(22) Filed: Oct. 6, 2011

(30) Foreign Application Priority Data
Oct. 8, 2010 (DE) 20 2010 014 013.7

(51) Int. Cl. A01K 27/00

(52) U.S. Cl. 119/859

(57) ABSTRACT

An animal light collar including a band, a housing, and a lighting device within the housing, such that the light collar is configured to fit around the neck of the animal. The band includes two ends connected to the housing. A portion of the lighting device, more specifically a battery-powered, light emitting diode, is inserted into ends of the band. The band further includes light scattering portions to distribute the light from the lighting device at the ends evenly throughout the band.

### TECHNICAL FIELD

The invention concerns a light collar for animals.

### BACKGROUND

Light collars aid in making domestic animals, in particular dogs, visible in the dark. For that purpose, light collars are fitted to the neck of the dog as a warning light in addition to the dog's collar and leash in order to make the dog visible in the dark, thereby avoiding collisions or the like with other road users. Additionally, the dog handler can also more easily see where the animal is located during such conditions.

A commercially available light collar is known from the corporation Leuchtie comprising a transparent tube of circular shape which is provided in its interior with lighting elements. The Leuchtie light collar has a plurality of battery-operated lighting elements that light up the light collar along the entire length of the band. Consequently the power consumption is relatively high. Large batteries therefore have to be used to avoid frequent battery changes. However, such large batteries increase the weight of the collar and thereby decrease the resulting wearing comfort to the animal. Fitting the lighting elements within the tube further requires a large tube diameter so that wearing comfort is also restricted. Furthermore, the round shape of the light collar detracts from the wearing comfort. For instance, it may be more likely to slip off the animal's neck due to the force of gravity when its head is lowered.

For the foregoing reasons, there is a need to provide a light collar which has good illumination of the collar with a low level of power consumption and at the same time allows increased wearing comfort.

### SUMMARY

The light collar includes a band, a housing, and a lighting device. The band is flexible, transparent, and is configured to fit around the neck region of an animal. The band further includes two ends. The housing has two connecting portions adapted to connect the two ends of the band to the housing. The lighting device is operatively connected to a lighting element to emit light. Furthermore, the lighting element is arranged relative to at least one of the ends of the band to introduce emitted light through the end and into the band.

A light collar in accordance with one embodiment of this invention emits light into the band, which, in turn, directs the light with uniform illumination. The lighting element emits light to and into the band at one end and thus passes the light into the band, the light then being further passed over the entire length of the band. Distributed over the length of the band, a part of the light is refracted at the surface of the band so that the band directs light towards its exterior. The light transition at the surfaces occurs in accordance with Snell's law of refraction. Accordingly, only light rays that are incident on the surface at an angle greater than the limit angle project from the band.

The refractive index of the band is in the range of between 1.2 and 2, preferably in the range of between 1.5 and 2, and particularly preferably in the range of between 1.75 and 2. The band is thus transparent in the non-illuminated condition.

In addition, the band may have a flat surface perpendicularly to the direction of its main extent to permit efficient light introduction. The end of the band can be easily cut off by means of a knife, shears, or the like to produce a flat end and to alter the length thereof. That is readily possible as the band is made from a bendable or flexible material with no electronics of the lighting device within the band.

To close the band to form a collar, the light collar has a housing with at least two connecting portions which are respectively connected to the ends of the band to close the collar. The connection between the housing and the collar is reversibly releasable so that the collar can be readily shortened or replaced.

An advantageous embodiment of the light collar according to the invention is characterized in that the lighting element is arranged outside the band. In that way, the band and the lighting element are arranged independently of each other. For example, the band can be easily released from the connecting portion and re-connected thereto in order to adapt the length of the band. A connection with the lighting element does not have to be made when re-connecting the band.

In a further advantageous embodiment of the invention, the band has light-scattering portions. The light-scattering portions offer refractive surfaces for the light and cause the band to light up at specifically targeted locations. This permits particularly effective lighting of the band.

A particularly advantageous embodiment according to this invention is a light collar having light-scattering portions arranged at an inside surface of the band and/or within the band. In that way, the light-scattering portions are shielded from the environment. The outside surface of the band represents a protective casing for the light-scattering portions. In this way the light-scattering portions are protected from dirt, scratches or the like.

A further advantageous embodiment of the invention includes light-scattering portions in the form of grooves. The grooves are of a defined geometrical cross-section at which particularly advantageous light refraction effects can be achieved. Varying the cross-sectional geometry of the grooves makes it possible to provide refraction effects. For example, brighter light points, uniform illumination, etc., which permit a large number of different design configurations in terms of lighting of the light collar may be achieved.

A further advantageous embodiment of the light collar according to the invention is characterized in that the band is tubular and provided with a groove which extends helically around the band. This embodiment allows particularly good illumination of the band as the introduced light is particularly well refracted along the helical groove. This uniform lighting of the collar increases the visibility of the dog.

An advantageous embodiment of the light collar according to the invention comprises a band composed of a transparent core and shell, wherein the refractive index of the core is higher than that of the shell. This configuration makes it possible to achieve many variations in light patterns, as the band comprises sections of varying opacity. It is thus possible to produce striped or similar light patterns.

Another advantageous aspect of the invention is that it can have varying cross-sections along the longitudinal axes of the connecting portions, which are arranged angled relative to each other. In accordance with this embodiment, the light collar is of a drop-shaped form which prevents the collar from slipping off. The angled arrangement of the connecting portions provides that the light collar becomes narrower towards the connecting portions, this therefore affording the drop-shaped form of the light collar. In the fitted condition, the narrow side is oriented downwardly and remains hanging at the snout of the animal if the upper part of the band begins to slip.

A particularly preferred embodiment of the light collar according to the invention is one in which the longitudinal axes of the connecting portions are arranged at an angle of less 180°, preferably in the range of between 70° and 130°, and particularly preferably in the region of 90°±10°. This embodiment of the invention allows the light collar to be of a shape which can be particularly easily fitted to the animal and which, at the same, time reliably prevents the light collar from slipping off.

A further aspect of the light collar according to this invention is characterized by the housing and each connection between the connecting portion and the band being water-tight. The light collar is thus splash-proof and water-tight to a depth of several meters. Testing has shown that the housing and the connections remain tight even after several hours under water.

The water-tightness of the connection between the connecting portion and the band is particularly easily achieved by means of a further advantageous embodiment of the invention, in which the end of the band can be clamped within the connecting portion. In this embodiment, the band is gripped or squeezed within the connecting portion so that the contact surfaces between the band and the connecting portion are water-tight.

An advantageous embodiment has connecting portions with a passage into which the band is introduced, wherein the passage is at least partially narrowed to brace the band within the narrowed portion. In addition, each of the connecting portions has a screwthread on its outside surface onto which a respective closure cap can be screwed for additionally bracing the band. This makes it possible to ensure water-tightness. In particular, the water-tightness is easily restored even after the connection between the band and the connecting portion has been released and restored many times. This counteracts unintentional damage to the water-tight integrity of the light collar by the user.

A further advantageous embodiment of the light collar according to the invention is one in which the passage has an abutment cooperating with the end of the band to limit insertion of the band. The abutment is in the form of a projection or a step and provides that the band passes into the connecting portion only as far as the abutment. The position of the abutment defines the length of the band to be inserted into the connecting portion.

A particularly advantageous embodiment of the light collar according to the invention is one comprising a housing having a plurality of housing portions which are glued or welded together, in particular by ultrasonic welding. At the adjoining locations of two housing portions, the housing is glued or welded together so that no gap remains at the adjoining locations. The housing is thus made water-tight.

In addition, an advantageous embodiment of a light collar according to the invention provides that the housing in a view is substantially Y-shaped, the connecting portions project angularly from a main body of the housing, and the main body has a corresponding cavity. The connecting portions are angled symmetrically relative to the main body of the housing so that the light collar is of a symmetrical shape.

In an advantageous embodiment of the light collar, the lighting element and an electrical power supply device are arranged at least partially within the cavity of the main body. The center of gravity of the light collar is thereby displaced toward the housing.

A further advantageous embodiment of the light collar according to the invention has a lighting element which is formed from a light emitting diode arranged substantially in the passage of the connecting portion. The light emitting diode is arranged coaxially relative to the passage and close to the end part of the band so that light can be introduced in particularly advantageous fashion.

One advantageous embodiment of this invention has an elastically deformable region in the region of the main body. That deformable region is thus suitable for actuating an electronic arrangement disposed therebeneath, such as a switch for the light emitting diodes.

Another advantageous embodiment of the invention has a housing having an access opening for the electrical power supply device which is closable and sealable by means of a cover. This embodiment more specifically permits easy replacement of the power supply device of one or more button cells, which can be performed without particular tools or knowledge.

A further advantageous embodiment of the invention is one in which the band is made from thermoplastic elastomer, in particular thermoplastic urethane. When made of this material, the band allows good deformability of the band for tightly clamping it.

A further advantageous embodiment of the light collar provides that the housing is made from a material selected from the group containing acrylonitrile-butadiene-styrenes. This material is particularly, well-suited to for providing water-tight contact surfaces.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 shows a plan view of a light collar.

FIG. 2 shows a plan view of the inside of a front housing portion of the light collar.

FIG. 3 shows a plan view of the lighting device of the light collar.

FIG. 4 shows a perspective view of the inside of a rear housing portion of the light collar.

FIG. 5 shows a plan view of the outside of the rear housing portion.

FIG. 6 shows a perspective view of a cover for an access opening of the rear housing portion.

FIG. 7 shows a side view of the cover.

### DETAILED DESCRIPTION

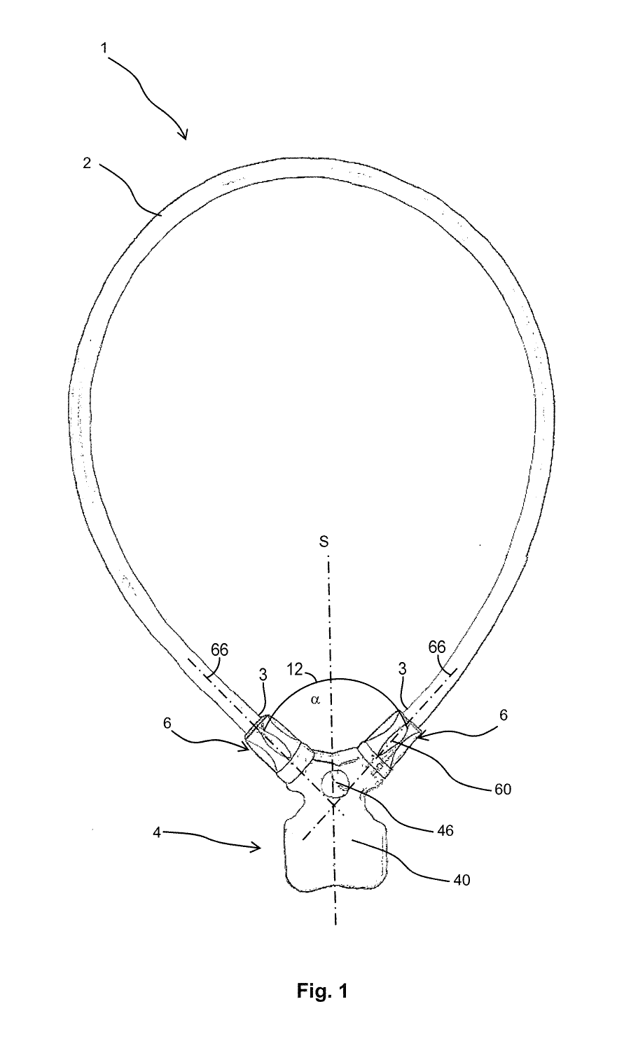

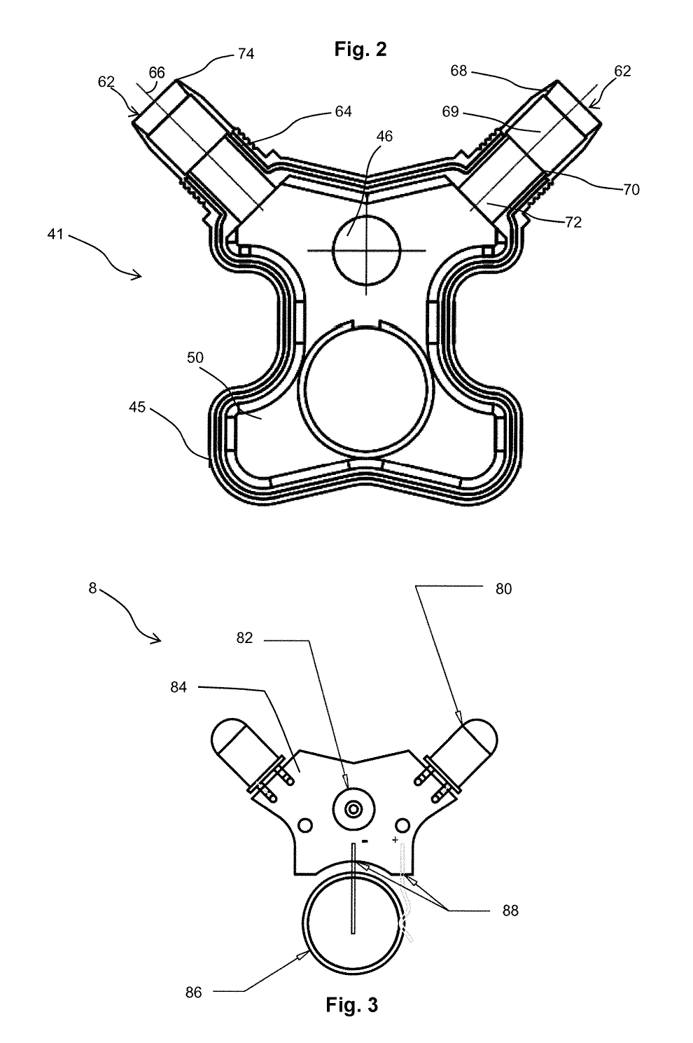

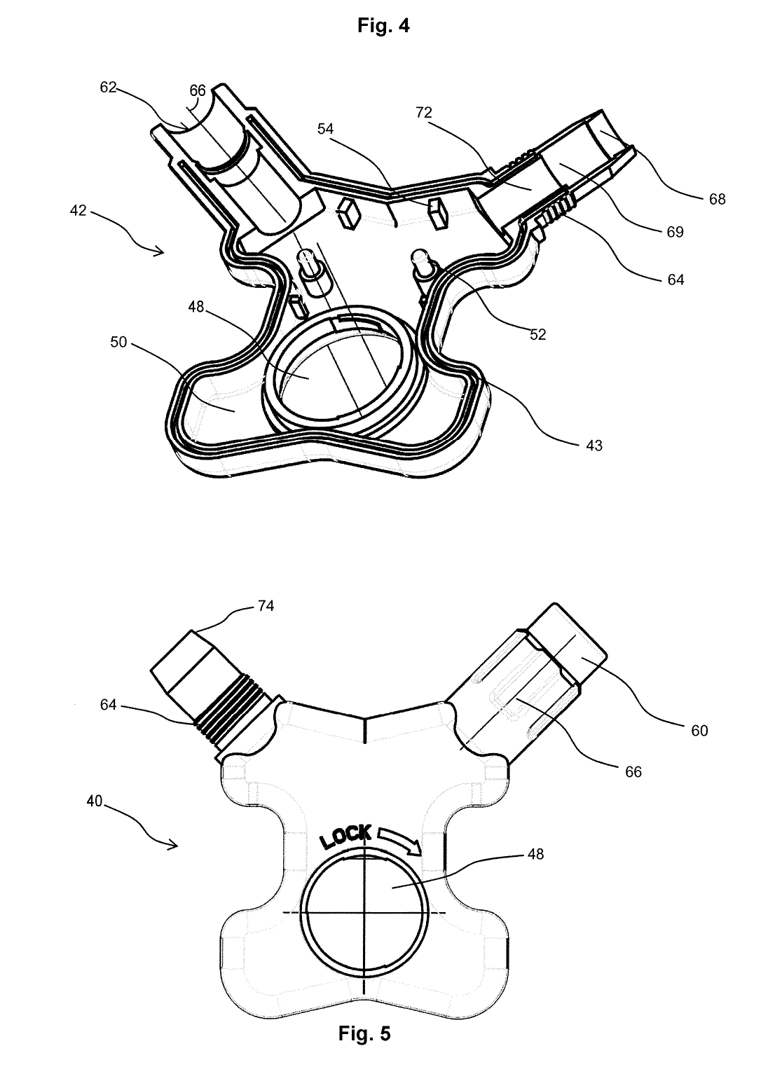

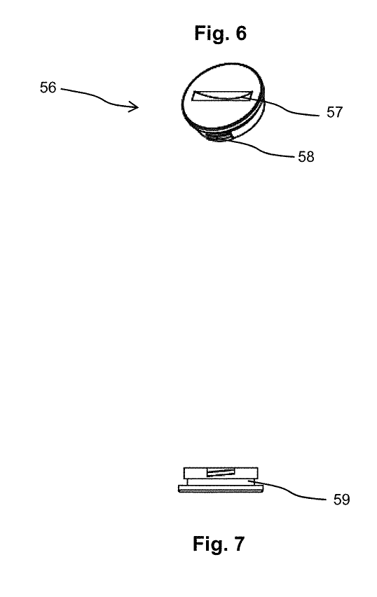

With regard to FIGS. 1-7, FIG. 1 shows a light collar 1 for dogs comprising a transparent and flexible band 2 for fitting around a neck region, a housing 4 with two connecting portions 6 for connecting the ends 3 of the band 2 to the housing 4. Closure caps 60 are screwed onto the connecting portions 6. Disposed within the housing 4 is a lighting device 8, as shown in FIG. 3, for lighting up the band 2. The lighting device 8 includes two lighting elements 80 in the form of light emitting diodes 80.

The band 2 is tubular, wherein a light-scattering portion in the form of band grooves extending helically are provided at the inside surface of the band 2. These grooves are not shown in the Figures. The grooves are preferably of an isosceles triangular cross-section and provide for uniform illumination of the band 2. The ends 3 of the band 2 are cut off flat so that a perpendicular surface relative to the direction of its main extent is available for introducing the light. Light emitting diodes 80 are arranged at each end 3 of the band 2 opposite the surface. The band 2 is made of a transparent and flexible material and is easily bendable. The ends 3 of the band 2 are connected to the connecting portions 6 of the housing 4.

The housing 4 in the view in FIG. 1 is substantially Y-shaped. It has two connecting portions 6 arranged symmetrically relative to the axis S of a main body 40 of the housing 4. Disposed between the connecting portions 6 is the main body 40 having a cavity 50. The housing 4 has front and rear housing portions 41, 42. Arranged on the front housing portion 41 along the housing wall is a thin-walled projection 45. The projection 45 engages into an associated groove 43 within the wall of the rear housing portion 42 and provides a positively locking connection between the two housing portions 41, 42. For final assembly the housing portions 41, 42 are welded using ultrasonic welding, thus rendering them waterproof. The housing portions 41, 42 are made from an ABS plastic in an injection molding process.

The connecting portions 6 are tubular and angled relative to each other. They form a V-shaped portion of the housing 4 at an inner portion of the light collar 1. In this embodiment the longitudinal axis 66 of the connecting portions 6 are oriented at or approximately at an angle 12 of α=90°. Other embodiments may have an angle 12 of less than 180°, preferably between 70° and 130° and particularly preferably in the range of 90°+/−10°.

Disposed in the interior of each of the connecting portions 6 is a passage 62, into which an end 3 of the band 2 is inserted. The passage 62 has a plurality of portions, of which a narrowed portion 68 narrows toward the housing 4. The narrowed portion 68 cooperates with the band 2 in such a way that, upon being inserted into the passage 62, the band 2 is clamped or squashed and the contact surfaces are therefore water-tight. The passage 62 also has an abutment 70 in the second portion 69, which cooperates with the end 3 of the band 2 to limit insertion of the band 2. The abutment 70 is in the form of a projection into the passage 62 and provides that the band 2 cannot penetrate into the connecting portion 6 beyond the abutment 70. A third portion 72 is provided for receiving the light emitting diode 80. An outside surface 64 of the connecting portion 6 is a screwthread 64, onto which a respective closure cap 60 can be screwed. To more easily screw on the closure cap 60, the connecting portion 6 has a conically tapering end portion 74.

The closure cap 60 also has a cap passage for passing the band 2 therethrough. The diameter of the cap passage is of such a size that the cap passage and closure cap form a press fitting between the outside surface 64 of the connecting portion 6 and the inside surface of the cap passage. In the screwed-on condition, the closure cap 60 presses the wall of the connecting portion 6 against the band 2 so that the band 2 is clamped within the connecting portion 6. This clamping leads to a water-tight and firm contact between the connecting portion 6 and the band 2. The outside of the closure cap 60 has a gripping profile which improves the transmission of force to the closure cap 60 in the screwing operation.

The main body 40 of the housing 4 is substantially rectangular in basic shape. Provided at two opposite side surfaces of the main body 40 are respective recesses offering a gripping surface for gripping the main body 40. An elastically deformable region 46, which is deformable with finger pressure, can be seen at the outside of the front housing portion 41 in the region of the main body 40. In this embodiment, the main body 40 has a recess in that region, which is filled with a rubber disk 46. The connection between the rubber disk 46 and the main body 40 is water-tight. The rubber disk 46 is placed at the location at which there is also a switch 82 for the lighting device 8.

In addition, disposed at the insides of the main body 40 are positioning elements 52, 54 for an electrical power supply device 86 for the lighting device 8 in the form of a button cell 86. Disposed on the outside of the rear housing 42 is an access opening 48 which is closable and sealable by means of a cover 56, for and used to replace the button cell 86. The cover 56 is provided with a cover screwthread 58 and can be screwed into the access opening 48. For that purpose, the cover 56 has a slot 57 on its outside surface 64. In addition, a cover groove 59 is arranged beneath the cover surface for water-tightly closing the access opening 48, with a sealing ring being fitted into the groove to form a water-tight seal. Further positioning elements 52, 54 are provided at the inside of the rear housing portion 42 for fixing the lighting device 8 to the band 2.

The lighting device 8 includes two light emitting diodes 80, a circuit board 84 with a switch 82 and an electrical power supply device 86, more specifically, two button cells 86. The light emitting diodes 80 are arranged substantially in the third portion 72 of the passage 62 directly adjacent to the end of the band 2, thereby ensuring that light is effectively introduced. The light emitting diodes 80 are connected to two button cells 86 by way of a circuit board 84 and two contact cables 88. The cables 88 are connected at a contact plate beneath the button cells 86 to permit simple replacement of the button cells 86.

The embodiments described herein only show possible combinations of the features involved. It does not limit the subject-matter of the invention to the illustrated and described combination and implementation of features. What is claimed is:

1-21. (canceled)

22. A light collar for an animal, comprising;
a transparent, flexible band configured to fit around a neck region of the animal and including a pair of ends;
a housing including two connecting portions, the two connecting portions adapted to connect the ends of the band to the housing; and
a lighting device including at least one lighting element operative to emit light,
wherein the lighting element is arranged relative to at least one of the band ends to introduce emitted light through at least one of the band ends and into the band.

23. The light collar of claim 22 wherein the lighting element is positioned outside of the band.

24. The light collar of claim 22 wherein the band further includes a light-scattering portion.

25. The light collar of claim 24 further including an inner band surface, wherein the light-scattering portion is positioned at the inner band surface and/or within the band.

26. The light collar of claim 24 wherein the light-scattering portion is a band groove.

27. The light collar of claim 22 wherein the band is tubular and further includes a band groove, the band groove extending helically around the band.

28. The light collar of claim 22 wherein the band includes a transparent core and a shell, wherein the refractive index of the transparent core is higher than the refractive index of the shell.

29. The light collar of claim 22 wherein each of the two connecting portions each include a longitudinal axis, and the longitudinal axes are oriented at an angle to each other.

30. The light collar of claim 29 wherein the angle of the longitudinal axes relative to one another is less than 180°.

31. The light collar of claim 29 wherein the angle of the longitudinal axes relative to one another is between 70° and 130°.

32. The light collar of claim 29 wherein the angle of the longitudinal axes relative to one another is 90°±10°.

33. The light collar of claim 22 wherein the housing and each connection between the connecting portions and the band are water-tight.

34. The light collar of claim 22 wherein the ends of the band are clamped within the respective connecting portions.

35. The light collar of claim 22 wherein the connecting portions have an outside surface and further include;
a passage, the passage being located within the connecting portions and having a narrowed portion;
a screwthread, the screwthread placed on the outside surface of the connecting portions; and
a closure cap, the closure cap positioned on the band and configured to screw onto the screwthread,
wherein the band is introduced onto the connecting portions at the narrowed portion, such that the closure cap is screwed onto the screwthread to brace the band.

36. The light collar of claim 35 wherein the passage further includes an abutment, the abutment cooperating with the end of the band to limit the introduction of the band.

37. The light collar of claim 35 wherein the lighting element is a light emitting diode, the light emitting diode positioned substantially within the passage.

38. The light collar of claim 22 wherein the housing includes a plurality of housing portions, the plurality of housing portions affixed together by being at least one of: glued, welded, and/or ultrasonic welded.

39. The light collar of claim 22 wherein the housing has a Y-shape and includes a main body, and the connecting portions project angularly from the main body.

40. The light collar of claim 39 further including an electrical power supply device, the electrical power supply device operatively connected to the lighting element, wherein the electrical power supply device and the lighting element are positioned within the cavity of the main body.

41. The light collar of claim 39 wherein the main body includes an elastically deformable region.

42. The light collar of claim 22 further including;
an access opening, the access opening located within the housing;
a cover, the cover removably affixed at the access opening and configured to close and seal the access opening; and
an electrical power supply device, the electrical power supply device located within the housing and accessible through the access opening.

43. The light collar of claim 22 wherein the band is thermoplastic elastomer.

44. The light collar of claim 43 wherein the thermoplastic elastomer is thermoplastic urethane.

45. The light collar of claim 22 wherein the housing is formed from a material including acrylonitrile-butadiene-styrenes.
